(19) United States
(12) Patent Application Publication
(10) Pub. No.: US 2015/0352569 A1
(43) Pub. Date: Dec. 10, 2015

(54) SUPERSONIC INJECTION NOZZLE WITH INTEGRATED SPRAY WIDTH CONTROL DEVICE

(71) Applicants: Myung Sik CHOI, (US); TAESAN COATING ENG, Incheon (KR)

(72) Inventors: Myung Sik CHOI, Incheon (KR); Il Sung HAN, Incheon (KR)

(21) Appl. No.: 14/759,733

(22) PCT Filed: May 23, 2013
(86) PCT No.: PCT/KR2013/004522

§ 371 Date: Jul. 8, 2015

(30) Foreign Application Priority Data
Jun. 15, 2012 (KR) 10-2012-0064167

(51) Int. Cl. B05B 7/24; B05B 1/28; B05B 17/06

(52) U.S. Cl. CPC B05B 7/2491; B05B 17/06; B05B 1/28

(57) ABSTRACT

A supersonic injection nozzle comprises: nozzle body part provided with inflow chamber in the inner portion; nozzle sleeve equipped in the nozzle body part and injection liquid being supplied in the inner portion; ultrasonic oscillator installed at the inflow chamber and vibrating the nozzle sleeve with ultrasonic waves and making the injected liquid passing through the inner portion of the nozzle sleeve atomized particles; compression air guide part installed in the front side of the nozzle body part and of which the front part of the nozzle sleeve is exposed from the front end and which has at least two liquid ejection holes provided at symmetrical position, wherein the ejection holes are connected to the inflow chamber of the nozzle body part and inclinedly supply the compressed air to the section of the liquid ejection holes provided at the front end of the nozzle sleeve.

### FIELD OF THE INVENTION

The invention relates to supersonic injection nozzle with integrated spray width control device, and more particularly, to supersonic injection nozzle with integrated spray width control device wherein, when spraying the liquid which has the viscosity like the paint on the surface of the object to be coated by the paint, the jet liquid does not splatter from the surface of the coated object so that the waste factor of the jet liquid may be prevented.

The invention relates to supersonic injection nozzle with integrated spray width control device which may control the directivity of the atomized particle of the jet liquid and may improve the coating efficiency for the spraying object(so to speak, the object to be coated by the paint).

And, the invention relates to supersonic injection nozzle with integrated spray width control device wherein the separate auxiliary device for controlling the directivity of the atomized particle of the jet liquid may not be required so that the desirable result like as the improvement of work efficiency and the productivity may be expected.

### DESCRIPTION OF THE RELATED ART

Generally, there are many cases of spraying the paint using the atomizer like the spray gun in case of coating the spraying object by the paint. The injection system (for example, spray gun) for changing liquid into the atomized particle state (Atomization) uses the power of the relatively high compressed air of 2˜3 kg/cm². That is, the injection system (coating system) may coat the paint on the surface of the spraying object after it makes the liquid (so to speak, the liquid paint) into the atomized particles to spray them (the atomized particles) on the surface the spraying object by the air of the high pressure supplied from the compressed air generating device like the air compressor. By the way, there is a problem that, in case of spraying the liquid with the injection system like as the spray gun, the jet liquid may be wasted so much because the jet liquid splatters from the surface of the coated. In case the jet liquid is the paint, the paint may be wasted so much.

In the meantime, the injection system of the liquid using the vibration of ultrasonic has been developed to be used in the present. The supersonic vibration liquid jet apparatus may make the liquid the fine particles using the vibration of the vibrator and may spray the fine particles on the surface of the spraying object. This ultrasonic liquid jet apparatus does not use the power of the compressed air at all but uses only the vibration of ultrasonic. Accordingly, the ultrasonic liquid jet apparatus has the advantage that there is no case of the waste of the jet liquid because the jet liquid does not splatter from the surface of the coated object when spraying the liquid in comparison with the general spray gun. However, the ultrasonic liquid jet apparatus has the disadvantage that, in case of actual paint coating task, the auxiliary device should be used for inducing the directivity of the atomized liquid by using the compressed air. For the ultrasonic liquid jet apparatus sprays the atomized liquid on the spraying object without the compressed and may be unable to control the directivity of the particles (jet liquid particles).

### SUMMARY OF THE INVENTION

The invention has been made to solve the foregoing problems with the prior art, and therefore the purpose of the invention is to provide supersonic injection nozzle with integrated spray width control device wherein, when spraying the liquid which has the viscosity like the paint on the surface of the object to be coated by the paint, the jet liquid does not splatter from the surface of the coated object so that the waste factor of the jet liquid may be prevented.

The purpose of the invention is to provide supersonic injection nozzle with integrated spray width control device which may control the directivity of the atomized particle of the jet liquid and may improve the coating efficiency for the spraying object(so to speak, the object to be coated with the paint).

And, the purpose of the invention is to provide supersonic injection nozzle with integrated spray width control device wherein the separate auxiliary device for controlling the directivity of the atomized particle of the jet liquid may not be required so that the desirable result like as the improvement of work efficiency and the productivity may be expected.

The main purpose of the invention is to provide supersonic injection nozzle with integrated spray width control device wherein the compressed air discharge unit is unitized in the ultrasonic injection system and the convenience of use may be increased as well as the paint with high viscosity may be atomized sufficiently by spraying the compressed air of the low pressure of predetermined angle to the end of the vibration nozzle. Generally, when atomizing the paint by the ultrasonic nozzle, although the fine particles by the vibration may be generated, in case the viscosity is high, the droplets may be combined again so the minute atomization may not be acquired. However, the invention may provide supersonic injection nozzle with integrated spray width control device wherein the droplets may not be reunited to be maintained at the particulate state, at the same time, the pattern advantageous for the coating condition may be formed to make the smooth paint coating task possible.

### BRIEF DESCRIPTION OF THE DRAWINGS

The above and other aspects, features and advantages of certain exemplary embodiments of the invention will be more apparent from the following description taken in conjunction with the accompanying drawings, in which:

FIG. 1 is a perspective view of the invention

FIG. 2 is a perspective view showing the front side of FIG. 1

FIG. 3 is a dissembled perspective view of the compression air guide part of FIG. 2

FIG. 4 is a front view of the nozzle body part illustrated in FIG. 3

FIG. 5 is a front view of the invention

FIGS. 6 to FIG. 8 are the top cross-sectional view which schematically shows the internal configure of the invention.

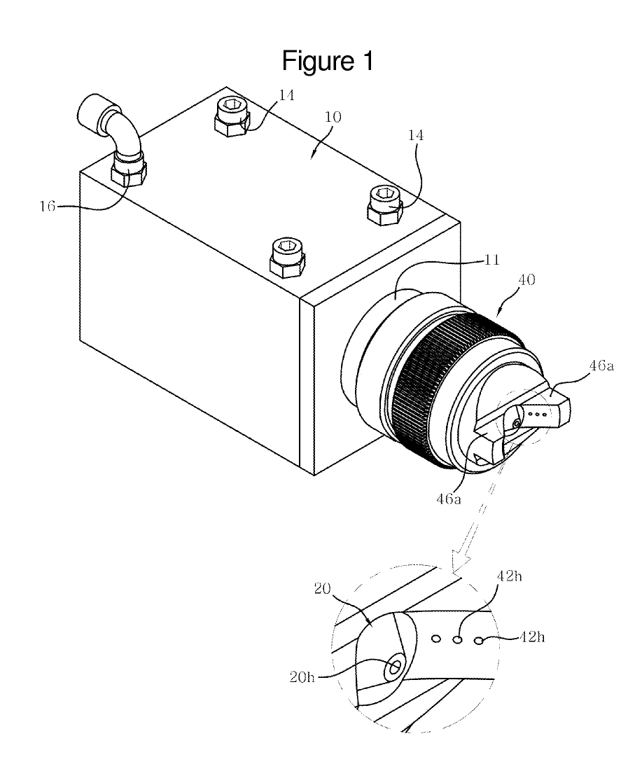

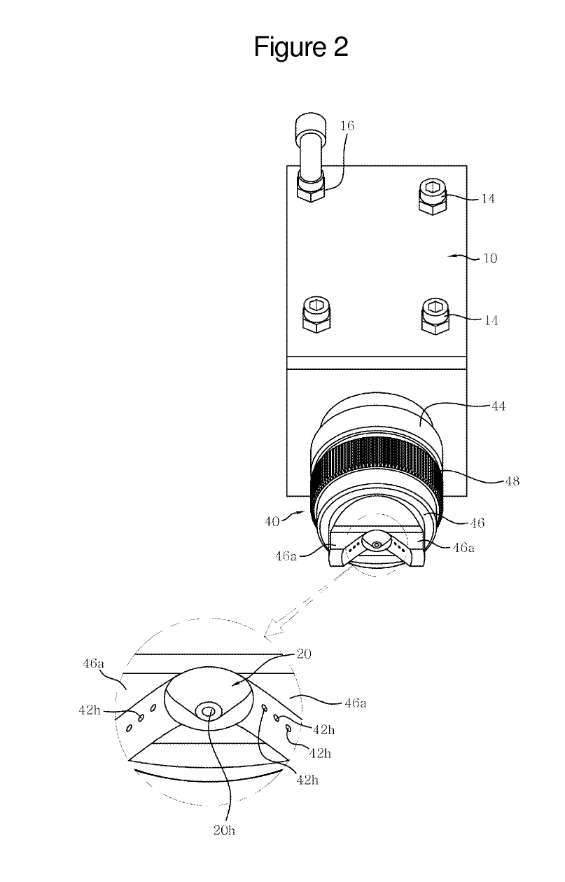

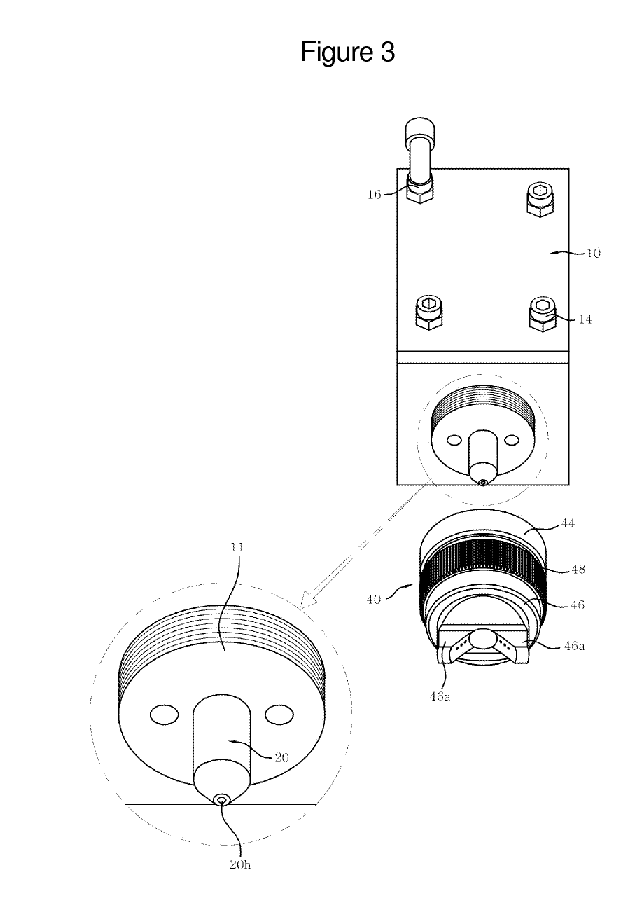

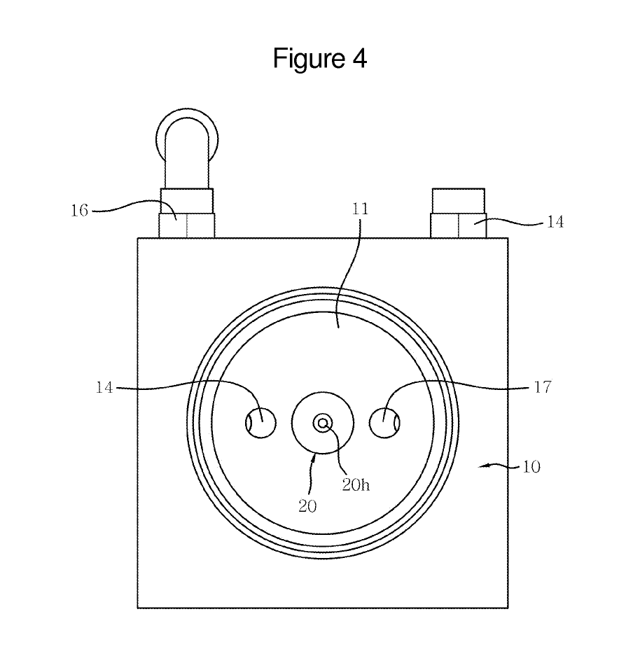

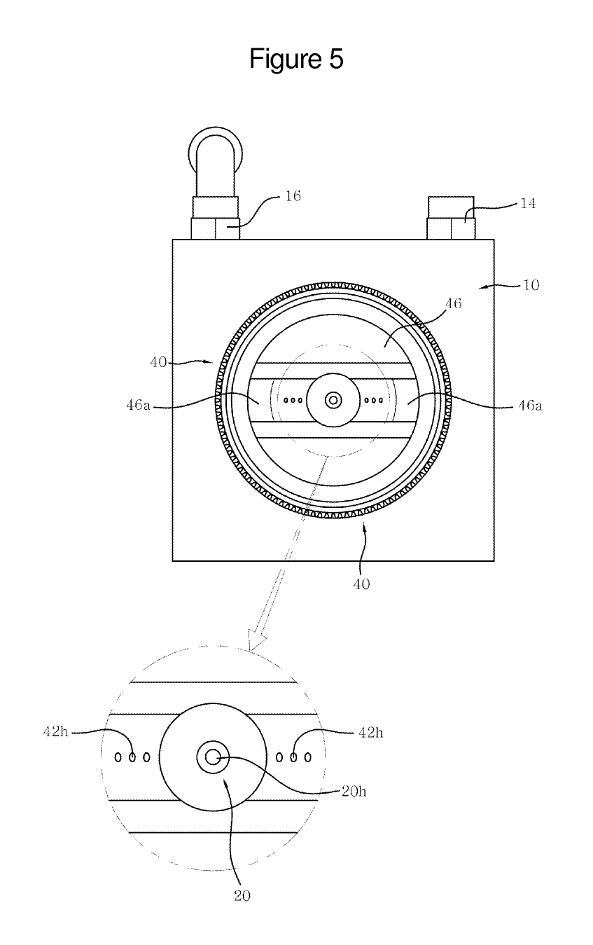

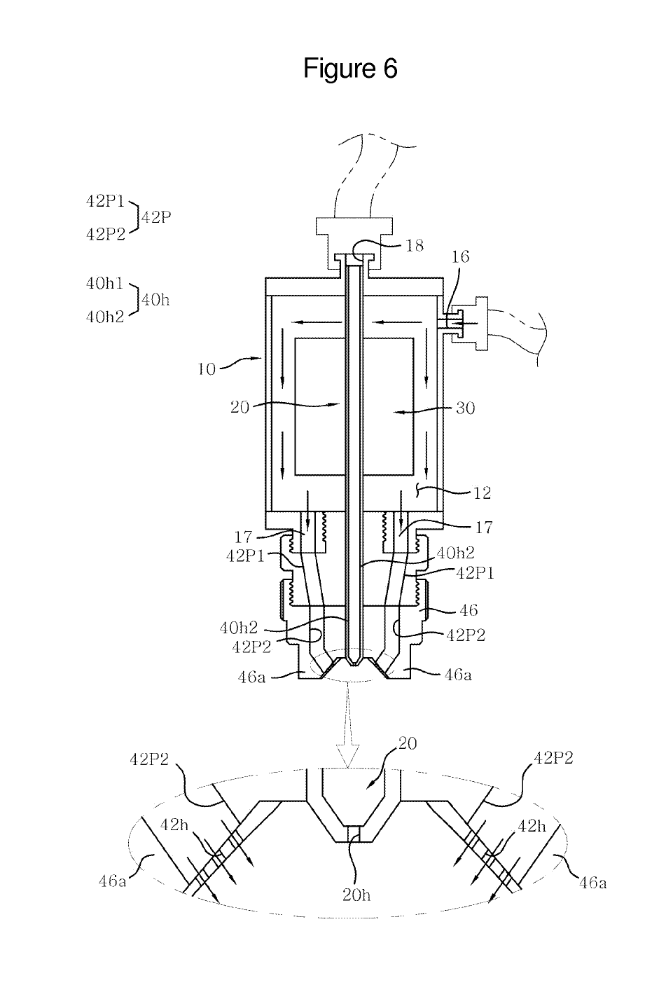

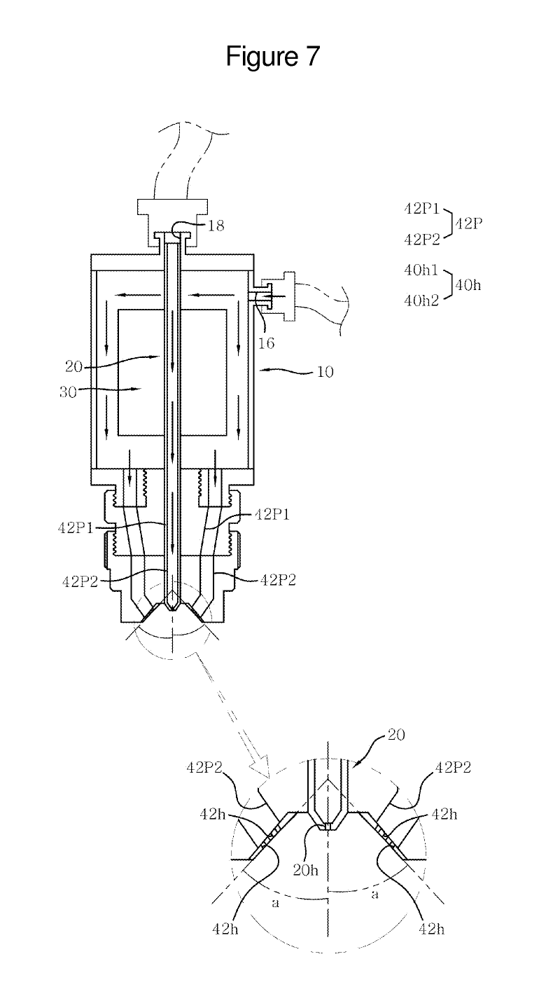

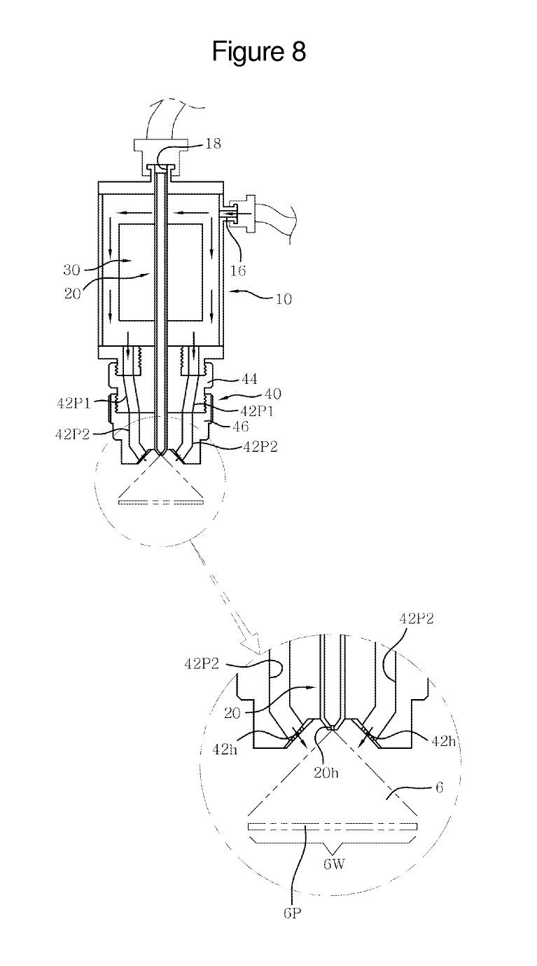

### DETAILED DESCRIPTION OF THE INVENTION

The invention will now be described more fully hereinafter with reference to the accompanying drawings, in which exemplary embodiments thereof are shown.

Referring to the attached drawings, supersonic injection nozzle with integrated spray width control device of the invention has the structure in which nozzle sleeve 20 and compression air guide part 40 are combined in nozzle body part 10 equipped with inflow chamber 12 for supplying compressed air in the inner portion. The invention has the characteristic that the waste factor of the spray liquid may be prevented efficiently because the spray pattern (the jet pattern) may be controlled when the liquid with the viscosity like the paint is sprayed on the surface of the spraying object, and the coating efficiency for the spraying object(so to speak, the object to be coated with the paint) may be increased remarkably because the directivity of the atomized particle of the jet liquid may be controlled efficiently.

The nozzle body part 10 is form of cube box shape equipped with the inflow chamber 12 in the inner portion. The compressed air may flow in the inflow chamber 12. The threaded hole is formed in the front side of the nozzle body part 10. And, in one side of the nozzle body part 10, the bracket bolt 14 to be fixed to the coating device and so on is provided at one side of the nozzle body part 10. Moreover, the compressive air input part 16 may be formed at the upper side of the nozzle body part 10. And, the compressed air feeder (for example, the compressor) is connected to this compressive air input part 16 by the connector (for example, the elbow tube etc) and hose etc. And the rear surface of the nozzle body part 10 may be provided with the liquid pouring hole 18 for the coating. The liquid pouring hole 18 for the coating is connected to spray liquid feeder (in the present invention, the paint supplier) by hose and so on. Here, said spray liquid means the liquid having the viscosity characteristic. The air discharging portion base 11 may be formed at the front side of the nozzle body part 10. And, the screw part is formed at the outer periphery of the air discharging portion base 11. And the screw part formed at the inner periphery of the rear end of the nozzle tip 44 is threadedly combined to the screw part of the air discharging portion base 11. Here, the nozzled tip 44 is a part of the compression air guide part 40 to be described below. Accordingly, the compression air guide part 40 may be equipped at the front side of the nozzle body part 10. Of course, the air discharging portion base 11 may be provided with the air hole 17 which is connected to the compressed air guide path 42P of the inner portion of the compression air guide part 40 while being connected to the inflow chamber 12 of the inner portion of the nozzle body part 10. At this time, two or more air holes 17 can be equipped in the position which is symmetrical based on the central part of the air discharging portion base 11.

The invention comprises nozzle sleeve 20. The nozzle sleeve 20 is installed at the inner portion of the nozzle body part 10 and some part of the front end of the nozzle sleeve 20 is protruded toward the front side of the nozzle body part 20. The injected liquid 6 is supplied to the inward portion of the nozzle sleeve 20. This nozzle sleeve 20 has the shape of strait pipe. The rear end portion of the nozzle sleeve 20 is connected to the liquid pouring hole 18 for the coating positioned at the rear end portion of the nozzle body part 10 as well as the outer periphery of the front end portion of the nozzle sleeve 20 is combined in the sleeve connection hall 40h formed in the front side of the nozzle body part 10. The outer periphery of the front end portion of the nozzle sleeve 20 may slide in the sleeve connection hall 40h. Accordingly, some outer periphery of the front end portion of the nozzle sleeve 20 and the liquid jet hall 20h may be exposed to the front side of the nozzle body part 10.

The ultrasonic oscillator 30 is installed in the inflow chamber 12 of the nozzle body part 10. At this time, the ultrasonic oscillator 30 is formed of block shape having predetermined volume. The ultrasonic oscillator 30 is combined to the outer periphery of the nozzle sleeve 20. In the meantime, the ultrasonic oscillator 30 may be formed of the supersonic vibration member (for example, the piezo element etc) that may be vibrated if the power source is supplied by power supply unit. And the nozzle sleeve 20 is combined to the nozzle body part 10. The nozzle sleeve 20 may be moved forward and backward direction along the nozzle body part. Accordingly, if the ultrasonic oscillator 30 operates, the nozzle sleeve 20 may operate at the supersonic vibration mode so that the atomization which forms the liquid 6 into the fine particles may be performed when the liquid 6 (in the invention, the liquid 6 means the paint having the viscosity) passes through the inner portion of the nozzle sleeve 20 to be discharged from the liquid jet hall 20h of the front end part of the nozzle sleeve 20. The ultrasonic oscillator 30 is installed inside the inflow chamber 12 of the nozzle body part 10. If the ultrasonic oscillator 30 is operated at the state of ultrasonic vibrations, the front end portion of the nozzle sleeve 20 may be vibrated at the range of much more forward and backward vibration distance in comparison with the vibration distance of the end portion of the nozzle sleeve 20. Therefore, the atomization efficiency by the supersonic vibration is maximized. That is, although the ultrasonic oscillator 30 vibrates to a small extent of oscillation, the supersonic vibration is amplified to be transmitted to the front end portion of the nozzle sleeve 20 and the front end portion of the nozzle sleeve 20 may move to and fro at the range of considerably amplified distance in comparison with forward and backward direction vibration distance of the rear end portion of the ultrasonic oscillator 30. Accordingly, the atomization efficiency making the paint particles the fine particles may become maximized when the paint having the viscosity passes through the inner portion of the nozzle sleeve 20 to be discharged from the liquid jet hall 20h of the front end part of the nozzle sleeve 20. In fact, the point that the atomization of the liquid 6 (in the present invention, the liquid means the paint having the viscosity) is achieved should be understood. That is, when the liquid 6 (in other words, the paint) comes out from the liquid ejection holes 20h of the nozzle sleeve 20, the nozzle sleeve 20 vibrates along the longitudinal direction of the nozzle body part 10 in the state of supersonic vibration by the ultrasonic oscillator 30 and trembles off the paint so that the paint is atomized in fine particles. In other words, the atomization of the paint may be performed by supersonic vibration while the paint is sprayed from the liquid ejection hole 20h of the nozzle sleeve 20.

The invention comprises compression air guide part 40 which is installed in the front side of the nozzle body part 10 and of which the front part of the nozzle sleeve 20 is exposed from the front end and which has at least two liquid ejection holes 20h provided at symmetrical position and wherein the ejection holes 20h are connected to the inflow chamber 12 of the nozzle body part 10 and inclinedly supply the compressed air to the section of the liquid ejection holes 20h provided at the front end of the nozzle sleeve 20 to adjust the spraying pattern 6P which is emitted from the liquid ejection holes 20h of the nozzle sleeve 20.

The sleeve connection hole 40h bonded to the end portion side outer periphery of the nozzle sleeve 20 is formed in the central part of the compression air guide part 40. Moreover, the compression air guide part 40 includes the compressed air guide path 42p connected to at least two compressed air supply holes formed in the position which is symmetrical at the front side of the nozzle body part 10 based on the central part. The compressed air guide path 42p is provided in the inner portion of the compression air guide part 10.

According to the invention, the compression air guide part 40 may be comprised of nozzle tip 44 and air guider 46 (Horn member) equipped in this nozzle tip 44.

The nozzle tip 44 has coupling boss 44a in the rear end and screw part is formed at the outer periphery of this coupling boss 44a. The screw part formed at the outer periphery of the coupling boss 44a is threadedly combined in the screw hole formed in the front central part of the nozzle body part 10. The inside central part of the nozzle tip 44 may be provided with the first sleeve combining hole 40h1. Moreover, two or more first compression air guide path 42p1 symmetrical based on the central part is formed in the inner portion of the nozzle tip 44. And this first compression air guide path 42p1 is connected to the compressed air supply hole of the nozzle body part 10. Of course, the compressed air supply hole of the nozzle body part 10 may be the structure of being connected with the inflow chamber 12 of the inner portion and being connected with the compression air inlet part of the nozzle body part 10.

The air guider 46 is equipped in the front side of the nozzle tip 44. According to the invention, the air guider 46 may be combined to the front side of the nozzle tip 44 by the connection ring 48. The screw part is formed in the outer periphery of the nozzle tip 44. The screw part is formed in the inner periphery of the connection ring 48. And the support projection extended to the radius direction inner side is formed in the front end of the connection ring 48. The flange part extended in the outer periphery of the air guider 46 toward the radius direction outer side is equipped. If the screw part formed in the inner periphery of the connection ring 48 is threadedly combined with the outer periphery of the nozzle tip 44, the flange part of the air guider 46 is combined to the state hanging on the support projection of the connection ring 48. Therefore, the structure in which the air guider 46 is combined securely in the front side of the nozzle tip 44 can be taken. At this time, the liquid jet hole 20h of the nozzle sleeve 20 is exposed to the front side of the compression air guide part 40, two or more symmetrical air guide horns 46a may be formed at the compression air guide part 40, in other words, the air guider 46. And, at least one or more of the second compression air guide paths 42p2 are formed penetrating to the respective air guide horn 46a. The second compression air guide paths 42p2 may spray the compressed air at the symmetrical position of both sides based on the central part of the liquid jet hole 20h by the angle inclined toward the central portion of the nozzle sleeve 20. Moreover, the central part of the air guider 46 may be provided with the second sleeve combining hole (40h2) connected with the first sleeve combining hole 40h1 of the nozzle tip 44.

Therefore, the first compression air guide path 42p1 of the nozzle tip 44 and the second compression air guide path 42p2 of the air guider 46 may form the compressed air guide path 42P (it is connected to the inflow chamber 12 formed in the inner portion of the nozzle body part 10 through the air hole 17) of the compression air guide part 40. The first sleeve combining hole 40h1 and the second sleeve combining hole 40h2 may form the sleeve connection hole 40h covering the end portion outer periphery of the nozzle sleeve 20 installed in the nozzle body part 10. And the liquid jet hole 20h provide at the end portion of the nozzle sleeve 20 may be protruded toward the front direction from the sleeve connection ball 40h of the compression air guide part 40. And two or more compressed air guide paths 42p of the symmetrical position of the compression air guide part 40 may be arranged in the circumference position of the end portion of the liquid jet hole 20h formed in the nozzle sleeve 20.

In other words, the compression air guide holes 42p of the compression air guide part 40 are arranged at the position which is inclined from the longitudinal center line of the nozzle sleeve 20 by predetermined angle as well as face each other. Accordingly, the compressed air is sprayed from the position in which the compressed air is faced in the front end part of the compressed air guide holes 42P and the spray width of the sprayed liquid 6 may be controlled.

At this time, the modulation of the spraying pattern 6P of the injected liquid 6 means the modulation of the spray width 6w of the injected liquid 6. And the spray width 6w of the injected liquid 6 emitted from the liquid jet hole 20h of the nozzle sleeve 20 may be controlled at the linear type when the compressed air is emitted from each compressed air guide path 42P of the faced position as described above. That is, the injected liquid 6 is emitted from the liquid jet hole 20h at the state of the linear type spraying pattern 6p. The invention relates mainly to spray the viscosity liquid 6. That is, the invention is mainly employed to spray the liquid 6 (especially, the paint) which has the viscosity. If the paint is emitted from the liquid jet hole 20h formed in the end portion of the nozzle sleeve 20, the paint may be emitted at the state of the linear type spraying pattern 6p by the compressed air spouting from the compressed air guide path 42P of two symmetrical positions formed at the outer position of the liquid jet hole 20h of the nozzle sleeve 20.

Preferably, the compression air ejection holes 42h provided at the end part of the respective compressed air guide paths 42p are arranged at the position which is inclined from the longitudinal center line of the nozzle sleeve 20 to the outside in the acute angle range. In the present invention, the inclination angle range of the compression air ejection hole 42h provide at the compressed air guide path 42p is 15°˜35° based on the lengthwise central part of the nozzle sleeve 20. Accordingly, if the compressed air is discharged in the tilt angle range, the linear type pattern width of the paint can be enough added and can be subtracted in the necessary range and the coating efficiency nature of the paint may be enhanced more.

In the meantime, it should be understood that the compression air guide part 40 may be formed with single body structure as well as the compressed air guide path 42p, the sleeve connection hole 40h and coupling boss 44a may be equipped in the compression air guide part 40 of single body structure.

According to the invention, while the paint passes through the inner chamber of the nozzle sleeve 20 provided in the nozzle body part 10, the paint may be atomized in fine particles by supersonic vibration operation of the supersonic oscillator 30, and while the atomized paint particles comes out from the liquid jet hole 20h provided at the end portion of the nozzle sleeve 20, the compressed air may be supplied from the compression air guide hole 40h provided in the compression air guide part 40 toward the paint injection core part. The compressed air may be supplied at the symmetrical position of both sides based on the central part of the liquid jet hole 20h by the angle inclined toward the central portion of the nozzle sleeve 20. Accordingly, the paint is emitted to the linear type pattern.

Therefore, the invention may solve the problem of the prior art that the liquid is sprayed with the injection system like as the spray gun and the jet liquid may be wasted so much because the jet liquid splatters from the surface of the coated. And, unlike the prior art which has the problem that the auxiliary device should be used for inducing the directivity of the atomized liquid by using the compressed air because the ultrasonic liquid jet apparatus sprays the atomized liquid on the spraying object without the compressed and may be unable to control the directivity of the particles, the invention has the advantage that, because the directivity of the atomized particles of the jet liquid (that is, the sprayed liquid particles) may be controlled, the paint may be controlled at the state of the linear type pattern convenient for the paint coating to be ejected toward the coating object, the convenience for paint coating task may be remarkably increased and the efficiency of coating task may be also increased remarkably. Moreover, the invention has the advantage that, because the auxiliary device is not required for inducing the directivity of the atomized liquid, it is preferable at the point of economy and the structure of the invention.

In other words, the invention has the structure that the compressed air discharge unit is unitized in the ultrasound injection system the convenience of use may be increased as well as the low pressure compressed air having some degree of angle may be sprayed toward the end portion of the vibration nozzle so that even the paint of high viscosity may be atomized appropriately. Generally, in case of atomizing the paint by the ultrasonic nozzle, although fine particles may be generated by vibration, if the viscosity of the paint is high, the atomized droplets of the paint again is again reunited together so that fine atomization may not be performed. However, the invention keeps off that the droplets reunited and maintain the fine particulate state as well as the pattern advantageous for coating may be formed to make the paint coating task convenient and smooth.

The invention relates to ultrasonic injection nozzle with integrated spray width control device. Like this, the invention has the effects as follows, by having the structure wherein the ultrasound atomization apparatus is integrated with spray width control device.

1. Due to high arrival rate of the paint, the invention may save 70 percent of cost.

(1) The loss of cost in the spray gun coating: ($290 per one month)*0.8=$230(the arrival rate: 20 percent)

(2) The loss of cost in the spray gun coating by the invention: ($290 per one month)*0.1=Approximately $3(the arrival rate:: 90 percent)

Therefore, in comparison with the prior art, the invention may save approximately $200.

2. Exhaust system load amount may be reduced: The invention uses the less air pressure and the arrival rate of the paint may be high so that there is nearly no scattered pigment particles and the exhaust airflow is less.

(1) The exhaust volume of the general coating booth: 200 m³/min, The cost is about $19,000.

(2) The exhaust volume of the supersonic spray coating booth: 1-10 m³/min, The cost is about $280.

3. Reduction of the distribution system supply air: The exhaust volume is little and the air charge quantity reduces.

(1) The cost of the general distribution system: about $28,000˜$75,000.

(2) The system price in the ultrasonic wave spray of the invention: about $4,700.

Therefore, the distribution system operating cost may be saved: In winter season, heater operation cost is about $9,400. In summer season, refrigerator operating cost is about $9,400.

4. Due to increase of the arrival rate, the speed of production throughput may be increased and the labor cost may be decreased.

Unlike the prior art wherein many workers should simultaneously enter the work place of the equipment to perform the coating work, the invention adopts single equipment concept and the respective worker may be arranged to the single integrated coating equipment so that the coating task may require 20 workers unlike the prior art that 40 workers are require. Therefore, the personnel cost may be saved by about $38,000 per one month in comparison with the prior art the personal cost is about $76,000 per one month.

What is claimed is:

1. An ultrasonic injection nozzle with integrated spray width control device comprising:
nozzle body part provided with inflow chamber in the inner portion;
nozzle sleeve which is equipped in the nozzle body part and which injection liquid is supplied in the inner portion;
ultrasonic oscillator which is installed at the inflow chamber and vibrates the nozzle sleeve with ultrasonic waves and makes the injected liquid passing through the inner portion of the nozzle sleeve atomized particles;
compression air guide part which is installed in the front side of the nozzle body part and of which the front part of the nozzle sleeve is exposed from the front end and which has at least two liquid ejection holes provided at symmetrical position and wherein the ejection holes are connected to the inflow chamber of the nozzle body part and inclinedly supply the compressed air to the section of the liquid ejection holes provided at the front end of the nozzle sleeve to adjust the spraying pattern which is emitted from the liquid ejection holes of the nozzle sleeve.

2. The ultrasonic injection nozzle with integrated spray width control device of claim 1, wherein the compression air guide holes of the compression air guide part are arranged at the position which is inclined from the longitudinal center line of the nozzle sleeve by predetermined angle as well as face each other so that the compressed air is sprayed from the position in which the compressed air is faced in the front end part of the compressed air guide holes to control the spray width of the sprayed liquid.

3. The ultrasonic injection nozzle with integrated spray width control device of claim 2, wherein the spray width of the jet liquid emitted from the front end part of the liquid ejection hole of the nozzle sleeve is controlled by the linear type when the compressed air is emitted from the respective compressed air ejection holes arranged in the faced position as described above.

4. The ultrasonic injection nozzle with integrated spray width control device of claim 3, wherein the compression air ejection holes provided at the end part of the respective compressed air guide paths are arranged at the position which is inclined from the longitudinal center line of the nozzle sleeve to the outside in the acute angle range.

5. The ultrasonic injection nozzle with integrated spray width control device of claim 4, wherein the ultrasonic oscillator is combined in the outer periphery of the nozzle sleeve, and the nozzle sleeve is combined in the nozzle body part to be moved forward and backward, and while the ultrasonic oscillator is operated, the nozzle sleeve may perform the ultrasonic vibration along the longitudinal direction of the nozzle body part, and while the liquid of predetermined viscosity(for example, the paint) passes through the inner chamber of the nozzle sleeve to be sprayed out the liquid ejection hole provided at the front end of the nozzle sleeve, the atomization which forms the liquid into fine particles may be performed.

6. The ultrasonic injection nozzle with integrated spray width control device of claim 4, wherein the inclination angle range of the compression air ejection hole provide at the compressed air guide path is 15°˜35° based on the lengthwise central part of the nozzle sleeve.
